(19) United States
(12) Patent Application Publication
(10) Pub. No.: US 2021/0254626 A1
(43) Pub. Date: Aug. 19, 2021

(54) COMPRESSOR AND CHILLER INCLUDING THE SAME

(71) Applicant: LG ELECTRONICS INC., Seoul (KR)

(72) Inventors: Junhyuk JANG, Seoul (KR); Yoonjei Hwang, Seoul (KR)

(21) Appl. No.: 17/172,575

(22) Filed: Feb. 10, 2021

(30) Foreign Application Priority Data
Feb. 17, 2020 (KR) 10-2020-0019268

(51) Int. Cl. F04D 29/058; F04D 3/02; F04D 29/38; F04D 29/32

(52) U.S. Cl. CPC F04D 29/058; F04D 29/324; F04D 29/384; F04D 3/02

(57) ABSTRACT

The present disclosure relates to a compressor and a chiller including the same. The compressor according to an embodiment of the present disclosure includes: a rotating shaft extending in a longitudinal direction of the shaft; a blade disposed on an outer circumferential surface of the rotating shaft and having a first inclined surface and a second inclined surface; a first bearing module disposed on one side of the rotating shaft, having a third inclined surface spaced apart in parallel from one side of the blade, and disposed to surround the outer circumferential surface of the rotating shaft; and a second bearing module disposed on the other side of the rotating shaft, having a fourth inclined surface spaced apart in parallel from the other side of the blade, and disposed to surround the outer circumferential surface of the rotating shaft, wherein the third inclined surface is disposed opposite the first inclined surface, and the fourth inclined surface is disposed opposite the second inclined surface. Accordingly, production costs of the bearings may be reduced, and the bearings may be controlled in a simplified manner.

### CROSS-REFERENCE TO RELATED APPLICATION(S)

This application claims priority under 35 U.S.C. § 119 to Korean Application No. 10-2020-0019268 filed on Feb. 17, 2020, whose entire disclosure are hereby incorporated by reference.

### BACKGROUND OF THE INVENTION

### 1. Field of the Invention

The present disclosure relates to a compressor and a chiller including the same, and more particularly to a compressor and a chiller including the same in which by providing a blade formed of a ferromagnetic material and inclined with respect to an axial direction of a shaft, and by providing bearings disposed opposite the blade, production costs of the bearings may be reduced, and the bearings may be controlled in a simplified manner.

### 2. Description of the Related Art

An air conditioner is a device for discharging cool or hot air into a room to create a comfortable indoor environment. The air conditioner is installed to provide a more comfortable indoor environment for users by controlling indoor temperature and purifying indoor air. Generally, the air conditioner includes an indoor unit installed indoors and having a heat exchanger, and an outdoor unit having a compressor, a heat exchanger, etc., and configured to supply a refrigerant to the indoor unit.

In the air conditioner, a chiller system supplies chilled water to demand sources of chilled water, and provides cooling by heat exchange between a refrigerant, circulating through a refrigeration system, and chilled water circulating between the demand sources and the refrigeration system. As large-capacity cooling equipment, the chiller systems may be installed in large buildings and the like.

The following description will be given of a structure of a general chiller system.

As illustrated in FIG. 1, a general chiller system 1 includes, as main components, a compressor 10, a condenser 20, an expansion device 30, an evaporator 40, and a controller 50. Further, the general chiller system 10 has a refrigerant channel A.

The compressor 10 is a device for compressing gases, such as air, a refrigerant gas, etc., and is configured to compress the refrigerant and provide the compressed refrigerant to the condenser 20. The compressor 10 includes an impeller 11 for compressing the refrigerant, a rotating shaft 13 coupled to the impeller 11, and motors 12A and 12B for rotating the rotating shaft 13.

In addition, the compressor 10 includes a thrust blade 14 disposed perpendicular to the rotating shaft 13, thrust bearings 15 supporting the thrust blade 14 in an axial direction, journal bearings 16 supporting the rotating shaft 13, and gap sensors 17 and 18.

The condenser 20 is configured to cool the refrigerant by heat exchange between a high-pressure and high-temperature refrigerant, discharged from the compressor 10 and passing through the condenser 20, and a coolant.

The expansion device 30 delivers a liquid refrigerant to the evaporator 40 and allows the high-pressure refrigerant to pass through an expansion valve to be converted into a low-temperature and low-pressure refrigerant.

The evaporator 40 is configured to cool cold water while evaporating the refrigerant.

The refrigerant channel A includes: a channel through which the refrigerant compressed by the compressor 10 flows from the compressor 10 to the condenser 20; a channel through which the refrigerant condensed by the condenser 20 flows from the condenser 20 to the expansion device 30; a channel through which the refrigerant expanded by the expansion device 30 flows from the expansion device 30 to the evaporator 40; and a channel through which the refrigerant evaporated by the evaporator 40 flows from the evaporator 40 to the compressor 10.

The gap sensors 17 and 18 are sensors for sensing positions of the rotating shaft 13 and the thrust blade 14. Based on position information measured by the gap sensors 17 and 18, the controller 50 may control the current of the thrust bearings 15 and the journal bearings 16, to control the position of the rotating shaft 13.

In order to control the position of the rotating shaft 13, one or more thrust bearings 15 and two or more journal bearings 16 are generally provided.

Such bearings require high production costs, and as the number of bearings increases, the number of control variables to be controlled by the controller also increases. Accordingly, the general compressor 10, to which at least three or more bearings are required to be applied, has problems in terms of high production costs and complicated controlling.

### SUMMARY OF THE INVENTION

In order to solve the above problems, it is an object of the present disclosure to provide a compressor and a chiller including the same in which by providing a blade, formed of a ferromagnetic material and inclined with respect to an axial direction of a shaft, and bearings disposed opposite the blade, production costs of the bearings may be reduced.

Further, in order to solve the above problems, it is another object of the present disclosure to provide a compressor and a chiller including the same in which by providing a blade, formed of a ferromagnetic material and inclined with respect to an axial direction of a shaft, and bearings disposed opposite the blade, the bearings may be controlled in a simplified manner.

The objects of the present disclosure are not limited to the aforementioned objects and other objects not described herein will be clearly understood by those skilled in the art from the following description.

In accordance with an aspect of the present disclosure, the above and other objects can be accomplished by providing a compressor, including: a rotating shaft extending in a longitudinal direction of the shaft; a blade disposed on an outer circumferential surface of the rotating shaft and having a first inclined surface and a second inclined surface; a first bearing module disposed on one side of the rotating shaft, having a third inclined surface 151a spaced apart in parallel from one side of the blade, and disposed to surround the outer circumferential surface of the rotating shaft; and a second bearing module disposed on the other side of the rotating shaft, having a fourth inclined surface 152a spaced apart in parallel from the other side of the blade, and disposed to surround the outer circumferential surface of the rotating shaft, wherein the third inclined surface 151a is disposed opposite the first inclined surface, and the fourth inclined surface 152a is disposed opposite the second inclined surface.

Meanwhile, in the compressor according to an embodiment of the present disclosure to achieve the above objects, angles formed between each of the first inclined surface and the second inclined surface and an axial direction of the rotating shaft may be in a range of 20 to 60 degrees.

Meanwhile, in the compressor according to an embodiment of the present disclosure to achieve the above objects, angles formed between each of the first inclined surface and the second inclined surface and the axial direction of the rotating shaft may be acute angles and may be equal to each other.

Meanwhile, in the compressor according to an embodiment of the present disclosure to achieve the above objects, angles formed between each of the first inclined surface and the second inclined surface and the axial direction of the rotating shaft may be acute angles and may be different from each other.

Meanwhile, in the compressor according to an embodiment of the present disclosure to achieve the above objects, the blade may have a trapezoidal cross-section in the axial direction.

Meanwhile, in the compressor according to an embodiment of the present disclosure to achieve the above objects, the blade may have a triangular cross-section in the axial direction.

Meanwhile, in the compressor according to an embodiment of the present disclosure to achieve the above objects, the blade may be formed by stacking a plurality of hollow plates.

Meanwhile, in the compressor according to an embodiment of the present disclosure to achieve the above objects, the blade may be disposed on the outer circumferential surface of the rotating shaft so that a direction, in which the hollow plates are stacked, may be perpendicular to the axial direction.

Meanwhile, in the compressor according to an embodiment of the present disclosure to achieve the above objects, the blade may be formed of a ferromagnetic material.

Meanwhile, in the compressor according to an embodiment of the present disclosure to achieve the above objects, the first bearing module and the second bearing module may include a plurality of magnetic core rings disposed therein and spaced apart from each other.

Meanwhile, in the compressor according to an embodiment of the present disclosure to achieve the above objects, the first bearing module and the second bearing module may include a plurality of gap sensors disposed therein, wherein the gap sensors may measure a distance between the first inclined surface and the third inclined surface 151a of the first bearing module and a distance between the second inclined surface and the fourth inclined surface 152a of the second bearing module.

Meanwhile, in the compressor according to an embodiment of the present disclosure to achieve the above objects, the gap sensors may be equally spaced apart from each other in the first bearing module and the second bearing module.

Meanwhile, in the compressor according to an embodiment of the present disclosure to achieve the above objects, a controller may control the first bearing module and the second bearing module to limit vibration of the rotating shaft in the axial direction or in a direction perpendicular to the axial direction.

Meanwhile, in the compressor according to an embodiment of the present disclosure to achieve the above objects, the controller may calculate a position of the rotating shaft by receiving distance information from the gap sensors disposed in the first bearing module and the second bearing module, and in response to the position of the rotating shaft falling outside of a normal position range, the controller may control a current of at least one or more of the plurality of magnetic core rings disposed in the first bearing module and the second bearing module.

Other detailed matters of the exemplary embodiments are included in the detailed description and the drawings.

The compressor and the chiller including the same according to the present disclosure have the following effects.

First, by providing a blade formed of a ferromagnetic material and inclined with respect to an axial direction of a shaft, and bearings disposed opposite the blade, production costs of the bearings may be reduced.

Second, by providing a blade formed of a ferromagnetic material and inclined with respect to an axial direction of a shaft, and bearings disposed opposite the blade, the bearings may be controlled in a simplified manner.

The effects of the present disclosure are not limited to the aforesaid, and other effects not described herein will be clearly understood by those skilled in the art from the following description of the appended claims.

### BRIEF DESCRIPTION OF THE DRAWINGS

FIG. 1 is a diagram illustrating a general chiller and a compressor included therein.

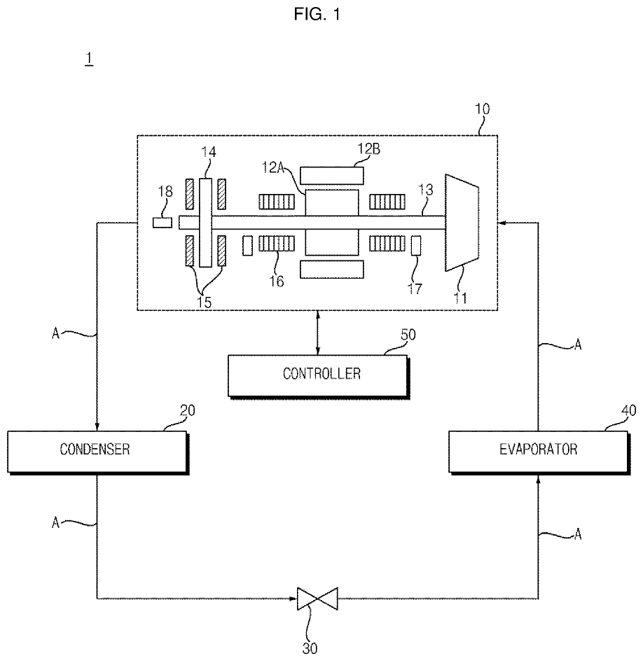

FIG. 2 is a diagram illustrating a chiller including a compressor according to an embodiment of the present disclosure.

FIG. 3 is a diagram illustrating a structure of a compressor according to an embodiment of the present disclosure.

FIG. 4 is a diagram illustrating a structure of bearing modules and a blade included in the compressor of FIG. 3.

FIG. 5 is a diagram illustrating a direction of a magnetic force applied by bearing modules to a blade.

FIG. 6 is a diagram illustrating a stacked structure of a blade included in a compressor according to an embodiment of the present disclosure.

FIG. 7 is a diagram illustrating a state in which the blade included in the compressor of FIG. 6 is coupled to a rotating shaft.

FIG. 8 is a diagram illustrating positions of gap sensors in a compressor according to an embodiment of the present disclosure.

FIG. 9 is a diagram illustrating a structure of core rings included in bearing modules of the compressor of FIG. 8.

FIG. 10 is a diagram illustrating positions of gap sensors in a compressor according to another embodiment of the present disclosure.

FIG. 11 is a diagram illustrating a controller according to an embodiment of the present disclosure.

### DETAILED DESCRIPTION OF THE PREFERRED EMBODIMENTS

The present disclosure will be described in further detail below with reference to the accompanying drawings.

In order to clearly and briefly describe the present disclosure, components that are irrelevant to the description will be omitted in the drawings. The same reference numerals are used throughout the drawings to designate the same or similar components, and a redundant description thereof will be omitted. Terms “module” and “unit” to refer to elements used in the following description are given merely to facilitate explanation of the description, without having any significant meaning or role by itself. Therefore, the “module” and the “unit” may be used interchangeably.

Further, descriptions of some well-known technologies that possibly obscure the invention will be omitted, if necessary. Further, the accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that, although the terms first, second, etc., may be used herein to describe various elements, these elements should not be limited by these terms. These terms are only used to distinguish one element from another.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

As used herein, the singular forms are intended to include the plural forms as well, unless the context clearly indicates otherwise.

It should be understood that the terms “comprise”, ‘include”, “have”, etc. when used in this specification, specify the presence of stated features, numbers, steps, operations, elements, components, or combinations of them but do not preclude the presence or addition of one or more other features, numbers, steps, operations, elements, components, or combinations thereof.

In the drawings, the thickness or size of each constituent element is exaggerated, omitted, or schematically illustrated for convenience of description and clarity. Also, the size or area of each constituent element does not entirely reflect the actual size thereof.

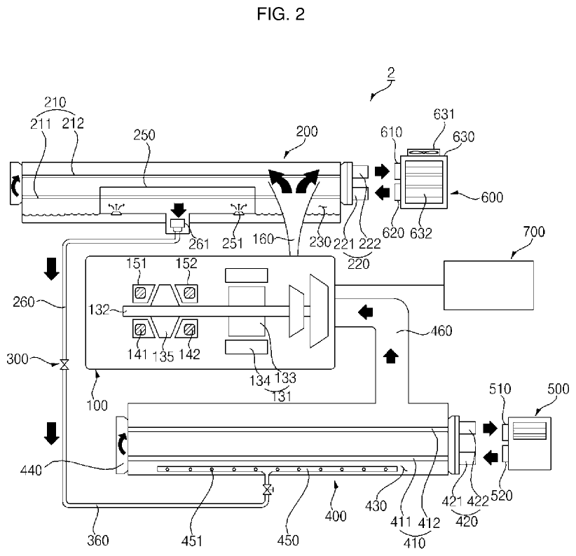

FIG. 2 is a diagram illustrating a chiller 2 including a compressor 100 according to an embodiment of the present disclosure.

The compressor 100 according to an embodiment of the present disclosure may not only function as part of a chiller but may also be included in an air conditioner and any other device as long as the device may compress a gaseous material.

Referring to FIG. 2, the chiller 2 according to an embodiment of the present disclosure includes: a compressor 100 configured to compress a refrigerant; a condenser 200 configured to condense the refrigerant by heat-exchange between the refrigerant, compressed by the compressor 100, and a coolant; an expander 300 configured to expand the refrigerant condensed by the condenser 200; an evaporator 400 configured to cool cold water while evaporating the refrigerant by heat-exchange between the refrigerant, expanded by the expander 300, and the cold water.

In addition, the chiller 2 according to an embodiment of the present disclosure may further include: a coolant unit 600 configured to cool the coolant heat-exchanged with the refrigerant at the condenser 200; an air conditioning unit 500 configured to cool air in an air conditioning space by heat-exchange between the cold water cooled at the evaporator 400 and the air in the air conditioning space; and a controller 700 configured to control operations of the air conditioning unit 500 and the compressor 100.

The condenser 200 provides a space for heat-exchange between a high-pressure refrigerant, compressed by the compressor 100, and the coolant introduced from the coolant unit 600. The compressed high-pressure refrigerant may be condensed by heat-exchange with the coolant.

The condenser 200 may include a shell-tube type heat exchanger. Specifically, the high-pressure refrigerant, compressed by the compressor 100, may be introduced into a condensing space 230, corresponding to an internal space of the condenser 200, through a condenser connection passage 160. Further, a coolant passage 210, through which the coolant introduced from the coolant unit 600 may flow, is formed in the condensing space 230.

The coolant passage 210 may include a coolant inlet passage 211, into which the coolant is introduced from the coolant unit 600, and a coolant discharge passage 212, through which the coolant is discharged to the coolant unit 600. The coolant introduced into the coolant inlet passage 211 may be heat-exchanged with the refrigerant inside the condensing space 230, and then may pass through a coolant connection passage 240, formed at one end inside the condenser 200 or formed outside thereof, to be introduced into the coolant discharge passage 212.

The coolant unit 600 and the condenser 200 may be connected to each other through a coolant tube 220. The coolant tube 220 may serve as a flow path of the coolant between the coolant unit 600 and the condenser 200, and may be made of a rubber material and the like so as to prevent the coolant from leaking to the outside.

The coolant tube 220 includes a coolant inlet tube 221 connected to the coolant inlet passage 211, and a coolant discharge tube 222 connected to the coolant discharge passage 212.

As for the overall coolant flow, after being heat-exchanged with air or a liquid at the coolant unit 600, the coolant is introduced into the condenser 200 through the coolant inlet tube 221. The coolant introduced into the condenser 200 sequentially passes through the coolant inlet passage 211, the coolant connection passage 240, and the coolant discharge passage 212 which are provided in the condenser 200, so as to be heat-exchanged with the refrigerant introduced into the condenser 200, and then passes through the coolant discharge tube 222 again to flow into the coolant unit 600.

In addition, the coolant unit 600 may perform air-cooling of the coolant after the coolant absorbs heat from the refrigerant by heat-exchange at the condenser 200. The coolant unit 600 includes a main body 630, a coolant inlet pipe 610 serving as an inlet through which the coolant after having absorbed heat is introduced from the coolant discharge tube 222, and a coolant discharge pipe 620 serving as an outlet through which the coolant after being cooled in the coolant unit 600 is discharged.

By using air, the coolant unit 600 may cool the coolant introduced into the main body 630. Specifically, the main body 630 has a fan generating an air flow, an air outlet 631 through which air is discharged, and an air inlet 632 through which air flows into the main body 630.

Air discharged through the air outlet 631 after being heat-exchanged may be used for heating. The refrigerant, condensed after being heat-exchanged at the condenser 200, stagnates in a lower portion of the condensing space 230. The stagnant refrigerant is fed into a refrigerant box 250, provided inside the condensing space 230, to flow into the expander 300.

The refrigerant box 250 may have a refrigerant inlet 251. The refrigerant, introduced into the refrigerant inlet 251, may be discharged through an expansion device connection passage 260. The expansion device connection passage 260 has an expansion device connection passage inlet 261 which may be disposed below the refrigerant box 250.

The evaporator 400 may include an evaporation space 430 in which heat-exchange takes place between the refrigerant, expanded by the expander 300, and cold water. In the expansion device connection passage 260, the refrigerant having passed through the expander 300 flows to a refrigerant injection device 450 provided in the evaporator 400, and passes through refrigerant injection holes 451 to spread evenly in the evaporator 400.

Further, in the evaporator 400, a cold water passage 410 is provided which includes: a cold water inlet passage 411, through which cold water flows into the evaporator 400; and a cold water discharge passage 412, through which the cold water is discharged outside of the evaporator 400.

The cold water may be introduced or discharged through a cold water tube 420 communicating with the air conditioning unit 500 provided outside of the evaporator 400. The cold water tube 420 includes a cold water inlet tube 421, serving as a passage through which cold water inside the air conditioning unit 500 flows toward the evaporator 400, and a cold water discharge tube 422 serving as a passage through which cold water after being heat-exchanged at the evaporator 400 flows toward the air conditioning unit 500. That is, the cold water inlet tube 421 communicates with the cold water inlet passage 411, and the cold water discharge tube 422 communicates with the cold water discharge passage 412.

As for the flow of cold water, after passing through the air conditioning unit 500, the cold water inlet tube 421, and the cold water inlet passage 411, the cold water passes through a cold water connection passage 440 provided at one end inside the evaporator 400 or provided outside thereof, and then flows into the air conditioning unit 500 again through the cold water discharge passage 412 and the cold water discharge tube 422.

The air conditioning unit 500 may perform heat exchange between cold water, cooled at the evaporator 400, and air in the air conditioning space. The cold water cooled at the evaporator 400 may absorb heat from the air in the air conditioning unit 500 to cool the indoor air. The air conditioning unit 500 may include a cold water discharge pipe 520 communicating with the cold water inlet tube 421, and a cold water inlet pipe 510 communicating with the cold water discharge tube 422. After being heat-exchanged at the evaporator 400, the refrigerant may flow into the compressor 100 again through a compressor connection passage 460.

As for the flow of the refrigerant, the refrigerant, introduced into the compressor 100 through the compressor connection passage 460, is compressed in a circumferential direction by the action of the impellers 110 and 120, and then is discharged through the condenser connection passage 160. The compressor connection passage 460 may be connected to the compressor 100 to allow the refrigerant to be introduced in a direction perpendicular to a rotation direction of the impellers 110 and 120.

The controller 700 may control a first bearing module 151 and a second bearing module 152, included in the compressor 100, to limit vibration of the rotating shaft 132 in the axial direction or in a direction perpendicular to the axial direction.

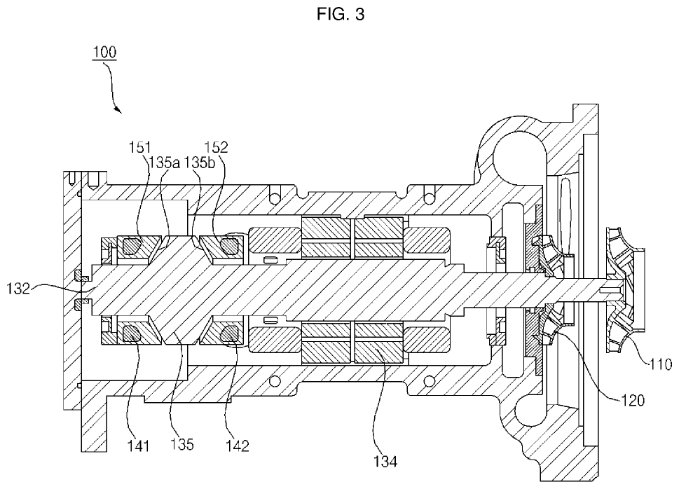

FIG. 3 is a diagram illustrating a structure of the compressor 100 according to an embodiment of the present disclosure.

Referring to FIGS. 2 and 3, the compressor 100 includes at least one or more impellers 110 and 120, a motor 131 rotating while being received in a motor housing, a rotating shaft 132, a blade 135 disposed on an outer circumferential surface of the rotating shaft 132, a first bearing module 151, and a second bearing module 152.

The impellers 110 and 120 may be single-stage or two-stage impellers, and multi-stage impellers may also be used. The impellers 110 and 120 are coupled to the rotating shaft 132 to be rotated by the rotating shaft 110, and may compress the refrigerant, introduced in the axial direction, into a high-pressure state by rotation in a centrifugal direction.

The motor 131 may include a stator 134 and a rotor 133 and may rotate the rotating shaft 132. The rotor 133 may be disposed on an outer circumference of the rotating shaft 132 and may rotate along with the rotating shaft 132. The stator 134 may be disposed inside the motor housing so as to surround the outer circumference of the rotor 133. The motor 131 may be provided with a rotating shaft separately from the rotating shaft 132, and may transmit torque to the rotating shaft 132 using a belt (not shown).

The rotating shaft 132 may be coupled to the motor 131. The rotating shaft 132 extends in a left-right direction of FIG. 3. In the following description, an axial direction of the rotating shaft 132 refers to the left-right direction. When the motor 131 rotates, the rotating shaft 132 is rotated to rotate the impellers 110 and 120.

The blade 135 may be disposed on the outer circumferential surface of the rotating shaft 132. The blade 135 may have a greater cross-sectional area than a cross-sectional area of the rotating shaft 132 on a plane perpendicular to the axial direction. The blade 135 may extend in a rotation radius direction (direction perpendicular to the axial direction) of the rotating shaft 132. The blade 135 may be tapered such that the cross-sectional area thereof on the plane perpendicular to the axial direction may decrease toward both ends of the blade 135. That is, a first inclined surface 135a and a second inclined surface 135b may be formed on both ends of the blade 135.

The first bearing module 151 may be disposed on one side of the rotating shaft 132, may be disposed to surround the outer circumferential surface of the rotating shaft 132, and may be spaced apart from one side of the blade 135. The first bearing module 151 may be disposed opposite (or facing) the first inclined surface 135a of the blade 135.

The second bearing module 152 may be disposed on the other side of the rotating shaft 132, maybe disposed to surround the outer circumferential surface of the rotating shaft 132, and may be spaced apart from the other side of the blade 135. The second bearing module 152 may be disposed opposite the second inclined surface 135b of the blade 135. Accordingly, both the first inclined surface 135a and the second inclined surface 135b of the blade 135 may be surrounded by the first bearing module 151 and the second bearing module 152.

The first bearing module 151 and the second bearing module 152 may include magnetic bearings. A plurality of magnetic core rings 141 and 142, which are spaced apart from each other, may be included in the first bearing module 151 and the second bearing module 152. A coil (not shown) may be wound around the magnetic core rings 141 and 142. The first bearing module 151 and the second bearing module 152 may serve as a magnet, with a current flowing through the wound coil 143. The first bearing module 151 and the second bearing module 152 may allow the rotating shaft 132 to rotate without friction while floating in the air.

The rotating shaft 132 may be desirably formed of a metal material so as to be moved by a magnetic force generated by the first bearing module 151 and the second bearing module 152. The blade 135 may be formed of a ferromagnetic material. Specifically, the blade 135 may be formed of a ferromagnetic metal or metal alloy.

In addition, the first bearing module 151 and the second bearing module 152 may restrict movement caused by vibration of the rotating shaft 132 in the axial direction, and may prevent the rotating shaft 132 from colliding with other components of the compressor 100 when the rotating shaft 132 moves in the axial direction during surge.

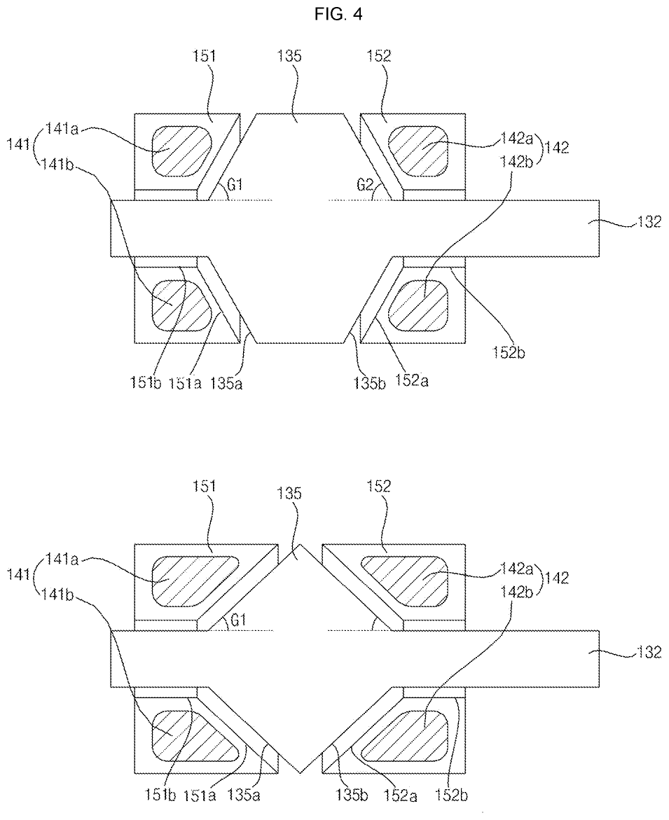

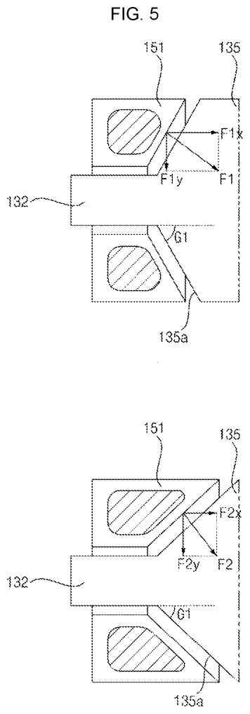

FIG. 4 is a diagram illustrating a structure of the bearing modules 151 and 152 and the blade 135 included in the compressor 100, and FIG. 5 is a diagram illustrating a direction of a magnetic force applied by the bearing modules 151 and 152 to the blade 135.

Referring to FIG. 4, the first bearing module 151 and the second bearing module 152 may have a trapezoidal cross-section, and may be formed in the shape of a donut to surround the outer circumferential surface of the rotating shaft 132.

One side surface of the first bearing module 151 may be spaced apart from the first inclined surface 135a of the blade 135a, and may have a third inclined surface 151a spaced apart in parallel from the first inclined surface 135a. The third inclined surface 151a may be parallel to the first inclined surface 135a.

A plurality of first magnetic core rings 141a and 141b, being spaced apart from each other, may be included in the first bearing module 151. The magnetic force generated by the first magnetic core rings 141a and 141b may be exerted in both vertical and horizontal directions of the blade 135.

One side surface of the second bearing module 152 may be spaced apart from the second inclined surface 135b of the blade 135, and may have a fourth inclined surface 152a spaced apart in parallel from the second inclined surface 135b. The fourth inclined surface 152a may be parallel to the second inclined surface 135b.

A plurality of second magnetic core rings 142a and 142b, being spaced apart from each other, may be included in the second bearing module 152. The magnetic force generated by the second magnetic core rings 142a and 142b may be exerted in both vertical and horizontal directions of the blade 135.

Angles G1 and G2 formed between each of the first and second inclined surfaces 135a and 135b of the blade 135 and the axial direction of the rotating shaft 132 may be acute angles.

The angles G1 and G2 may fall within a specific range. Specifically, a first angle G1, formed between the first inclined surface 135a and the axial direction of the rotating shaft 132, and a second angle G2 formed between the second inclined surface 135b and the axial direction of the rotating shaft 132 may be in a range of 20 to 60 degrees, and may be preferably 45 degrees.

If the first angle G1 and the second angle G2 are 90 degrees or are angles close to 90 degrees, the blade 135 may have the same shape as the thrust blade included in the general compressor. In this case, only a movement of the rotating shaft 132 in the axial direction may be controlled by the blade 135 and the first and second bearing modules 151 and 152, and a movement of the rotating shaft 132 in a direction perpendicular to the axial direction is hardly controlled thereby.

Likewise, if the first angle G1 and the second angle G2 are zero degrees or are angles close to zero degrees, only a movement of the rotating shaft 132 in the direction perpendicular to the axial direction may be controlled by the blade 135 and the first and second bearing modules 151 and 152, and a movement of the rotating shaft 132 in the axial direction is hardly controlled thereby.

If the first angle G1 and the second angle G2 are in a range of 20 to 60 degrees, the blade 135 and the first and second bearing modules 151 and 152 may effectively control movements of the rotating shaft 132 in both the axial direction and the direction perpendicular to the axial direction.

Referring to (a) of FIG. 5, a first magnetic force F1 generated by the first bearing module 151 or the second bearing module 152 may be exerted in a direction perpendicular to the first inclined surface 135a or the second inclined surface 135b. The first magnetic force F1 includes an axial componentF1x in the axial direction of the rotating shaft 132 and a vertical componentF1y perpendicular to the rotating shaft 132.

If the first angle G1 and the second angle G2 are in a range of 45 to 60 degrees, a magnitude of the axial component F1x of the first magnetic force F1 is greater than a magnitude of the vertical component F1y thereof. In this case, the blade 135 and the first and second bearing modules 151 and 152 may suppress a movement of the rotating shaft 132 in the axial direction more effectively.

Referring to (b) of FIG. 5, a second magnetic force F2 generated by the first bearing module 151 or the second bearing module 152 may be exerted in a direction perpendicular to the first inclined surface 135a or the second inclined surface 135b. The second magnetic force F2 includes an axial component F2x in the axial direction of the rotating shaft 132 and a vertical component F2y perpendicular to the rotating shaft 132.

If the first angle G1 and the second angle G2 are in a range of 20 to 45 degrees, a magnitude of the axial component F2x of the second magnetic force F2 is smaller than a magnitude of the vertical component F2y thereof. In this case, the blade 135 and the first and second bearing modules 151 and 152 may suppress a movement of the rotating shaft 132 in the direction perpendicular to the rotating shaft 132 more effectively.

In addition, if the first angle G1 and the second angle G2 are 45 degrees, a magnitude of the axial component F2x of the second magnetic force F2 is equal to a magnitude of the vertical component F2y thereof. In this case, the blade 135 and the first and second bearing modules 151 and 152 may effectively control movements in both the axial direction and the direction perpendicular to the rotating shaft 132.

Further, the first angle G1 and the second angle G2 may be equal to each other. If the first angle G1 and the second angle G2 are equal to each other, the first bearing module 135a and the second bearing module 135b may have the same shape. In this case, the blade 135 may be controlled by the first bearing module 135a and the second bearing module 135b in a simplified manner.

Moreover, the first angle G1 and the second angle G2 may be different from each other. If the first angle G1 and the second angle G2 are different, the first bearing module 135a and the second bearing module 135b may have different shapes.

In addition, referring to (a) of FIG. 4, the blade 135 may have a trapezoidal cross-section in the axial direction. If the first angle G1 and the second angle G2 are in a range of 45 to 60 degrees, the blade 135 may have a trapezoidal cross-section in the axial direction, thereby preventing an axial width of the blade 135 from becoming too thin.

Furthermore, referring to (b) of FIG. 4, the blade 135 may have a triangular cross-section in the axial direction. If the first angle G1 and the second angle G2 are in a range of 20 to 45 degrees, the blade 135 may have a triangular cross-section in the axial direction, thereby preventing an axial width of the blade 135 from becoming too thick.

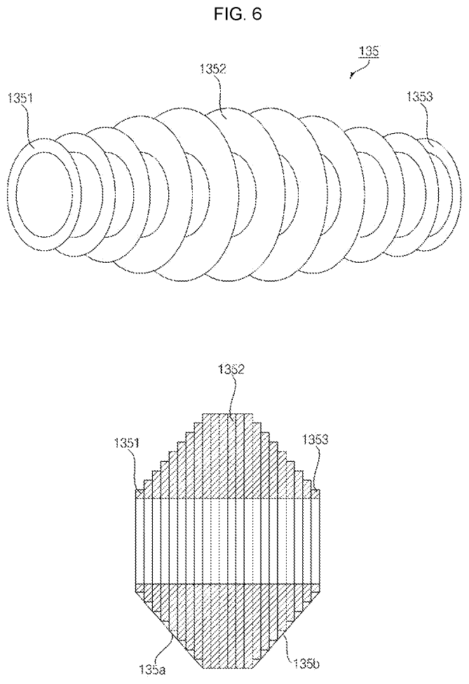

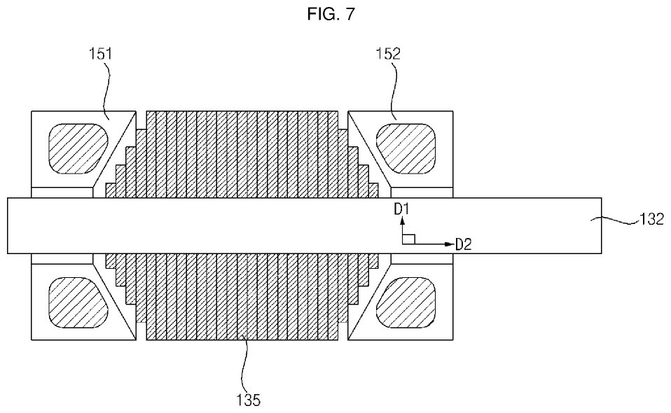

FIG. 6 is a diagram illustrating a stacked structure of the blade 135 included in the compressor 100 according to an embodiment of the present disclosure, and FIG. 7 is a diagram illustrating a state in which the blade 135 included in the compressor 100 of FIG. 6 is coupled to the rotating shaft 132.

Referring to (a) of FIG. 6, the blade 135 may have a structure in which a plurality of hollow circular plates 1351, 1352, and 1353 are stacked. The respective hollow circular plates 1351, 1352, and 1353 may have a circular hollow formed at the center thereof and having a diameter equal to a diameter of a vertical cross-section of the rotating shaft 132. The hollow circular plates 1351, 1352, and 1353 may be formed of a ferromagnetic material. Specifically, the blade 135 may be formed of a ferromagnetic metal or metal alloy.

A plurality of circular plates are stacked in such a manner that a plurality of circular plates 1352 having a relatively larger diameter are stacked at a center portion, and the circular plates 1351 and 1353 having a relatively smaller diameter are stacked at both ends of the blade 135, so that the diameter sequentially decreases toward the both ends of the blade 135.

Referring to (b) of FIG. 6, the plurality of hollow circular plates 1351, 1352, and 1353 are stacked to form the first inclined surface 135a and the second inclined surface 135b. An angle formed between each of the first and second inclined surfaces 135a and 135b and the axial direction of the rotating shaft 132 may vary according to the diameter of the stacked hollow circular plates 1351, 1352, and 1353. The first inclined surface 135a and the second inclined surface 135b may be formed in a stepped shape.

Referring to FIG. 7, the plurality of hollow circular plates 1351, 1352, and 1353 may be disposed on the outer circumferential surface of the rotating shaft 132, so that a diameter direction D1 of the respective plates 1351, 1352, and 1353 may be perpendicular to an axial direction D2 of the rotating shaft 132. As the plurality of hollow circular plates 1351, 1352, and 1353 are disposed perpendicular to the rotating shaft 132, the magnetic force generated by the first bearing module 151 and the second bearing module 152 may be transmitted effectively to the rotating shaft 132 through the blade 135.

The blade 135 may have a structure in which a plurality of hollow cylinders having different diameters and lengths are stacked, or may be an integrally formed ferromagnetic metal or metal alloy.

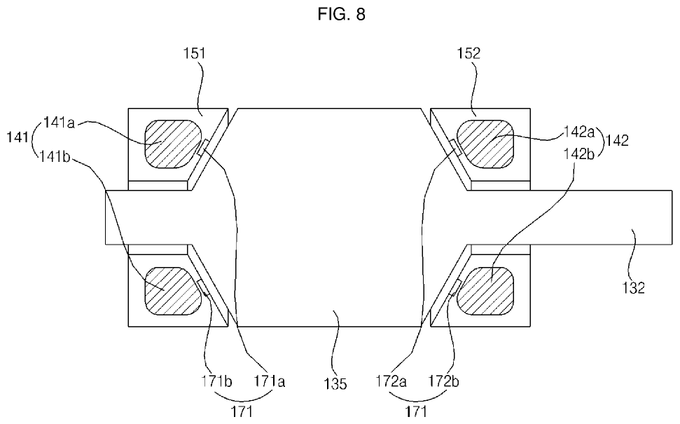

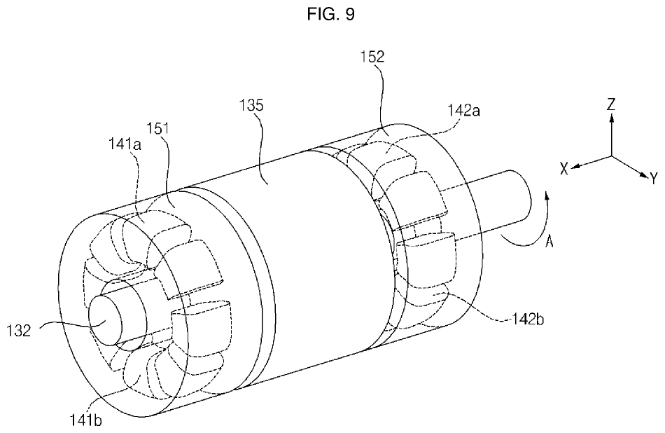

FIG. 8 is a diagram illustrating positions of the gap sensors 171 and 172 in the compressor 100 according to an embodiment of the present disclosure, and FIG. 9 is a diagram illustrating a structure of core rings 141 and 142 included in the bearing modules 151 and 152 of the compressor 100 of FIG. 8.

Referring to FIG. 8, the first bearing module 151 and the second bearing module 152 may include a plurality of gap sensors 171 and 172. A plurality of first gap sensors 171 may be included in the first bearing module 151, and a plurality of second gap sensors 172 may be included in the second bearing module 152.

The first gap sensors 171 may measure a distance between the first inclined surface 135a and the third inclined surface 151a of the first bearing module 151 or a change in the distance; and the second gap sensors 172 may measure a distance between the second inclined surface 135b and the fourth inclined surface 152a of the second bearing module 152 or a change in the distance. In this manner, the gap sensors 171 and 172 may measure accurate position information of the blade 135, and may measure movements of the rotating shaft 132 in both the axial direction and the direction perpendicular to the axial direction.

In addition, the plurality of first gap sensors 171a and 171b may be equally spaced apart from each other in the first bearing module 151, and the second gap sensors 172a and 172b may be equally spaced apart from each other in the second bearing module 152.

The plurality of gap sensors 171a, 171b, 172a, and 172b may transmit the measured distances or distance change information to the controller 700; and by considering all the distances measured by the plurality of gap sensors 171a, 171b, 172a, and 172b or the distance change information thereof, the controller 700 may identify position information of the blade 135, thereby increasing accuracy in measuring position information of the blade 135.

Referring to FIG. 9, the first bearing module 151 and the second bearing module 152 may include magnetic bearings. A plurality of first magnetic core rings 141a and 141b, being spaced apart from each other, and a plurality of second magnetic core rings 142a and 142b, being spaced apart from each other, may be included in the first bearing module 151 and the second bearing module 152, respectively.

A coil (not shown) may be wound around the magnetic core rings 141a, 141b, 142a, and 142b. The first bearing module 151 and the second bearing module 152 may serve as a magnet, with a current flowing through the wound coil 143. The first bearing module 151 and the second bearing module 152 may allow the rotating shaft 132 to rotate without friction while floating in the air.

The number of magnetic core rings, included in each bearing module, may be equal to the number of gap sensors included in each bearing module. Alternatively, the number of magnetic core rings, included in each bearing module, may be a multiple of the number of gap sensors included in each bearing module. For example, eight first magnetic core rings 141 and eight second magnetic core rings 142 may be spaced apart from each other in the first bearing module 151 and the second bearing module 152, respectively; and four first gap sensors 171 and four second gap sensors 172 may be spaced apart from each other in the first bearing module 151 and the second bearing module 152, respectively.

The plurality of first gap sensors 171a and 171b and second gap sensors 172a and 172b may be disposed adjacent to the plurality of magnetic core rings 141a and 141b and second magnetic core rings 142a and 142b. For example, the plurality of first gap sensors 171a and 171b may be disposed between the plurality of first magnetic core rings 141a and 141b and the third inclined surface 151a, so as to be adjacent to the third inclined surface 151a of the first bearing module 151 which is disposed opposite the first inclined surface 135a. The plurality of second gap sensor 172a and 172b may be disposed between the plurality of second magnetic core rings 142a and 142b and the fourth inclined surface 152a, so as to be adjacent to the fourth inclined surface 152a of the second bearing module 152 which is disposed opposite the second inclined surface 135b. In this arrangement, accuracy in measuring position information of the blade 135 may be improved.

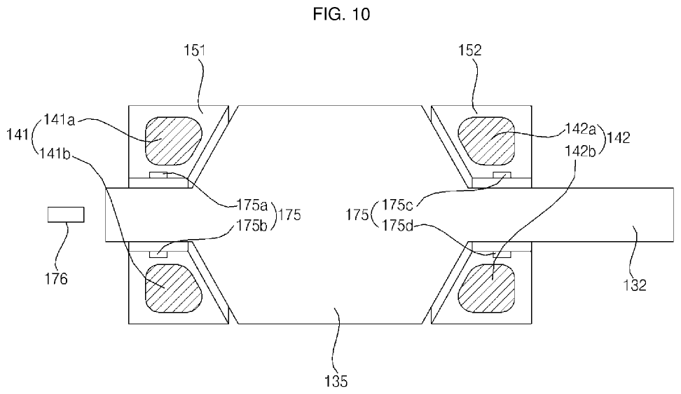

FIG. 10 is a diagram illustrating positions of gap sensors 175 and 176 in a compressor according to another embodiment of the present disclosure.

Referring to FIG. 10, the gap sensors 175 and 176 may include a third gap sensor 175 and a fourth gap sensor 176. There may be a plurality of third gap sensors 175.

The third gap sensor 175 may be disposed adjacent to a surface on which the first bearing module 151 and the second bearing module 152 face the rotating shaft 132. The plurality of third gap sensors 175a, 175b, 175c, and 175d may detect a distance from the rotating shaft 132 or a change in the distance, and may measure a movement of the rotating shaft 132 in the direction perpendicular to the axial direction based on the detected information.

The fourth gap sensor 176 may be disposed adjacent to an end of one side of the rotating shaft 132. The fourth gap sensor 176 may detect a distance from the rotating shaft 132 or a change in the distance, and may measure a movement of the rotating shaft 132 in the axial direction based on the detected information.

The third gap sensor 175 and the fourth gap sensor 176 may transmit the measured distance or distance change information to the controller 700, and the controller 700 may identify position information of the blade 135 by considering the distances or distance change information measured by the plurality of gap sensors 175 and 176.

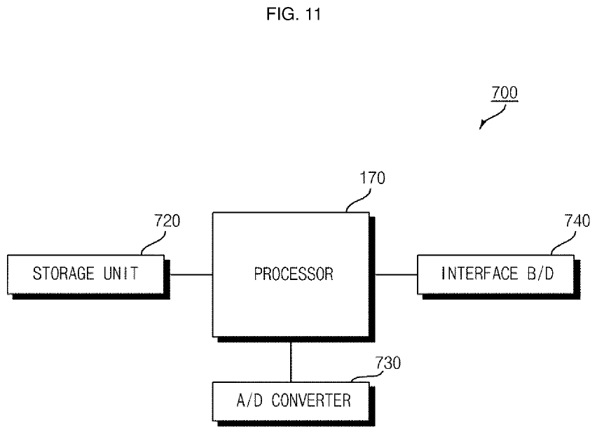

FIG. 11 is a diagram illustrating the controller 700 according to an embodiment of the present disclosure.

Referring to FIG. 11, the controller 700 includes a processor 710, a storage unit 720, an A/D converter 730, and an interface board 740.

The block diagram of the controller 700 illustrated in FIG. 11 shows one embodiment of the present disclosure. The respective components of the block diagram may be integrated, added, or omitted according to the specification of the controller 700.

Hereinafter, operations of the controller 700 will be described based on an example in which the gap sensors 171 and 172 are disposed adjacent to the first inclined surface 135a and the second inclined surface 135b.

The processor 710 may execute a control algorithm to control operations of the compressor 100 or the chiller 2 including the compressor 100. The control algorithm may be implemented by a computer program and may be executed by the processor 710, which is apparent to those skilled in the art. In addition, the controller 700 may further include a controller (not shown) executing a function separately from the processor 710.

By executing the control algorithm, the processor 710 may control the speed of the motor 131 or may control a degree of opening of a valve included in a circulation channel (not shown) or the expander 300.

The storage unit 720 may store the control algorithm. The control algorithm may be provided as a computer program or software and may be stored in the storage unit 720. The storage unit 720 may store normal position information or normal position range information of the rotating shaft 132.

The storage unit 720 may include at least one storage medium of a flash memory type memory, a hard disk type memory, a multimedia card micro type memory, a card type memory (e.g., an SD memory, an XD memory, etc.), a Random Access Memory (RAM), a Static Random Access Memory (SRAM), a Read Only Memory (ROM), an Electrically Erasable Programmable Read Only Memory (EEPROM), a Programmable Read Only Memory (PROM), a magnetic memory, a magnetic disk, and an optical disk, and the like.

The A/D converter 730 may convert analog signals, received from various sensors including gap sensors 171 and 172, into digital signals. The digital signals produced by the A/D converter 730 may be provided to the processor 710.

The interface board 740 may receive signals, associated with the operation of the compressor 100, from various sensors and components. For example, the interface board 740 may receive at least one or more of the following: temperature information of cold water discharged from the evaporator 400 to the cold water inlet tube 421; cooling pressure information of the evaporator 400 and the condenser 200; discharge temperature sensor information of the compressor 100; and oil temperature sensor information of the compressor 100.

The processor 710 of the controller 700 may control the first bearing module 151 and the second bearing module 152 by executing the control algorithm to control vibration of the rotating shaft 132 in the axial direction or in the direction perpendicular to the axial direction. Upon determining that abnormal vibration occurs in the rotating shaft 132, the processor 710 may control a display (not shown) to output an alarm.

The processor 710 may receive distance information or distance change information of the blade, which is measured by the gap sensors 171 and 172, and may calculate a position of the rotating shaft 132 based on the received information. Based on the calculated position information of the rotating shaft 132, the processor 710 may control a magnitude of a current applied to at least one or more of the plurality of first magnetic core rings 141a and 141b and second magnetic core rings 142 and 142b.

Based on the distance information measured by the gap sensors 171 and 172 and information on the first angle G1 or the second angle G2, the processor 710 may divide the measured distance information into distance information in the axial direction and distance information in the direction perpendicular to the axial direction. Based on the divided distance information, the processor 710 may calculate the position information in the axial direction and position information in the direction perpendicular to the axial direction of the blade 135. Based on the distance information measured by the plurality of gap sensors 171 and 172, the processor 710 may calculate accurate three-dimensional (3D) position information of the blade 135 or the rotating shaft 132.

The processor 710 may compare the calculated 3D position information of the blade 135 or the 3D position information of the rotating shaft 132 with normal position information or normal position range information stored in the storage unit 720, and may calculate force magnitudes F1x and F2x in the axial direction and force magnitudes F1y and F2y in the direction perpendicular to the axial direction, which are to be applied to the blade 135 through at least one or more of the first magnetic core rings 141a and 141b and the second magnetic core rings 142a and 142b. Based on the calculated force magnitudes, the processor 710 may calculate the magnitude of a current applied to at least one or more of the plurality of first magnetic core rings 141a and 141b and second magnetic core rings 142a and 142b, and may control the compressor 100 to apply the calculated current to the core rings.

In this manner, the processor 710 may control the rotating shaft 132, coupled to the blade 135, to be in a position or in a position range to allow for normal operation. The processor 710 may control all of vertical movement, horizontal movement, forward and backward movement, yawing, and pitching of the rotating shaft 135.

The processor 710 may compare a position of the rotating shaft 132 with the normal position information or the normal position range information which is stored in the storage unit 720; and if the position of the rotating shaft 132 falls outside of the normal position range, the processor 710 may determine that abnormality occurs in the rotating shaft 132. In this case, the processor 710 may control the display (not shown) to display warning alarm information.

In addition, the processor 710 may further include a communicator (not shown) and may transmit the warning alarm information to an external device through the communicator so that the warning alarm information may be displayed on a display of the external device.

Furthermore, if a position of the rotating shaft 132 falls outside of the normal position range, the processor 710 may stop the operation of the compressor 100 or the chiller 2, and may control the display to display information for guiding inspection of the compressor 100. Accordingly, a manager managing the chiller 2 may perform maintenance on the compressor 100 by checking the information for guiding inspection which is displayed on the display, and by inspecting the compressor 100 based on the information.

The storage unit 720 may accumulate and store operation information of the motor 131, and may accumulate and store distance information measured by the gap sensors 171 and 172.

As can be seen from the foregoing, the compressor and the chiller including the same in accordance with the above-described embodiments is not limited to the configurations and methods of the embodiments described above, but the entirety of or a part of the embodiments may be configured to be selectively combined such that various modifications of the embodiments can be implemented.

The compressor and the chiller including the same according to an embodiment of the present disclosure have an effect in that by providing a blade formed of a ferromagnetic material and inclined with respect to an axial direction of a shaft, and bearings disposed opposite the blade, production costs of the bearings may be reduced.

Furthermore, the compressor and the chiller including the same according to an embodiment of the present disclosure have an effect in that by providing a blade formed of a ferromagnetic material and inclined with respect to an axial direction of a shaft, and bearings disposed opposite the blade, the bearings may be controlled in a simplified manner.

While the present disclosure has been described and illustrated herein with reference to the preferred embodiments and diagrams thereof, the present disclosure is not limited to the aforementioned embodiments. It should be understood that various modifications of the embodiments are possible by those skilled in the art without departing the technical scope of the present invention defined by the appended claims, and the modifications should not be understood separately from the technical principles or prospects of the present disclosure.

What is claimed is:

1. A compressor comprising:
a rotating shaft extending in a longitudinal direction of the shaft;
a blade disposed on an outer circumferential surface of the rotating shaft and having a first inclined surface and a second inclined surface;
a first bearing module disposed on one side of the rotating shaft, having a third inclined surface spaced apart in parallel from one side of the blade, and disposed to surround the outer circumferential surface of the rotating shaft; and
a second bearing module disposed on the other side of the rotating shaft, having a fourth inclined surface spaced apart in parallel from the other side of the blade, and disposed to surround the outer circumferential surface of the rotating shaft,
wherein the third inclined surface is disposed opposite the first inclined surface, and the fourth inclined surface is disposed opposite the second inclined surface.

2. The compressor of claim 1, wherein angles formed between each of the first inclined surface and the second inclined surface and an axial direction of the rotating shaft are in a range of 20 to 60 degrees.

3. The compressor of claim 1, wherein angles formed between each of the first inclined surface and the second inclined surface and the axial direction of the rotating shaft are acute angles and are equal to each other.

4. The compressor of claim 1, wherein angles formed between each of the first inclined surface and the second inclined surface and the axial direction of the rotating shaft are acute angles and are different from each other.

5. The compressor of claim 1, wherein the blade has a trapezoidal cross-section in the axial direction.

6. The compressor of claim 1, wherein the blade has a triangular cross-section in the axial direction.

7. The compressor of claim 1, wherein blade is formed by stacking a plurality of hollow plates.

8. The compressor of claim 7, wherein the blade is disposed on the outer circumferential surface of the rotating shaft so that a direction, in which the hollow plates are stacked, is perpendicular to the axial direction.

9. The compressor of claim 1, wherein the blade is formed of a ferromagnetic material.

10. The compressor of claim 1, wherein the first bearing module and the second bearing module comprise a plurality of magnetic core rings disposed therein and spaced apart from each other.

11. The compressor of claim 1, wherein the first bearing module and the second bearing module comprise a plurality of gap sensors disposed therein,
wherein the gap sensors measure a distance between the first inclined surface and the third inclined surface of the first bearing module and a distance between the second inclined surface and the fourth inclined surface of the second bearing module.

12. The compressor of claim 11, wherein the gap sensors are equally spaced apart from each other in the first bearing module and the second bearing module.

13. The compressor of claim 1, further comprising a controller configured to control the first bearing module and the second bearing module to limit vibration of the rotating shaft in the axial direction or in a direction perpendicular to the axial direction.

14. The compressor of claim 11, wherein the controller calculates a position of the rotating shaft by receiving distance information from the gap sensors disposed in the first bearing module and the second bearing module, and controls a current of at least one or more of the plurality of magnetic core rings disposed in the first bearing module and the second bearing module.

15. A compressor comprising:
a rotating shaft extending in an axial direction;
a blade protruding in a radial direction from an outer circumferential surface of the rotating shaft, and having a first inclined surface and a second inclined surface;
a first bearing module spaced apart from the blade in the axial direction, having a third inclined surface, and disposed to surround the outer circumferential surface of the rotating shaft; and
a second bearing module spaced apart from the blade in a direction opposite the first bearing module, having a fourth inclined surface, and disposed to surround the outer circumferential surface of the rotating shaft,
wherein the third inclined surface is disposed opposite the first inclined surface, and the fourth inclined surface is disposed opposite the second inclined surface.

16. The compressor of claim 15, wherein the third inclined surface is parallel to the first inclined surface, and the fourth inclined surface is parallel to the second inclined surface.

17. The compressor of claim 15, wherein the first inclined surface and the second inclined surface form an acute angle with the axial direction of the rotating shaft.

18. The compressor of claim 15, wherein angles formed between each of the first inclined surface and the second inclined surface and the axial direction of the rotating shaft are acute angles and are different from each other.

19. The compressor of claim 15, wherein the blade has a trapezoidal cross-section in the axial direction.

20. The compressor of claim 15, wherein the blade is formed of a ferromagnetic material.
